(19) United States
(12) Patent Application Publication
(10) Pub. No.: US 2012/0161857 A1
(43) Pub. Date: Jun. 28, 2012

(54) CHARGE PUMP CIRCUIT

(75) Inventor: Makoto SAKAGUCHI, Otsu (JP)

(73) Assignee: Renesas Electronics Corporation

(21) Appl. No.: 13/325,725

(22) Filed: Dec. 14, 2011

(30) Foreign Application Priority Data
Dec. 22, 2010 (JP) 2010-286090

(51) Int. Cl. G05F 1/10

(52) U.S. Cl. 327/536

(57) ABSTRACT

A charge pump circuit includes first to fifth transistors disposed between a power supply terminal and an output terminal; first to fourth capacitive components between the junctions of the first to fifth transistors and one of first and second clock input terminals; sixth to tenth transistors between the power supply terminal and the output terminal; and fifth to eighth capacitive components between the junctions of the sixth to tenth transistors and one of the first and second clock input terminals. The conduction state of the fifth transistor is controlled according to the potential of a first node. The conduction state of the tenth transistor is controlled according to the potential of a second node. Each transistor is disposed on a triple well, and an n-well and a p-well are electrically coupled to each other in at least the triple wells forming the first to fourth and six to ninth transistors.

### CROSS-REFERENCE TO RELATED APPLICATIONS

The disclosure of Japanese Patent Application No. 2010-286090 filed on Dec. 22, 2010 including the specification, drawings and abstract is incorporated herein by reference in its entirety.

### BACKGROUND

The present invention relates to a charge pump circuit and in particular to a charge pump circuit suitable for reducing current consumption.

In recent years, reductions in current consumption have been a problem with negative charge pump circuits (charge pump circuits for negative voltage generation) for use in portable electronic apparatuses such as cellular phones.

FIG. 5 is a circuit diagram showing a negative charge pump circuit according to the related art. (The diagram corresponds to FIG. 15 of Japanese Unexamined Patent Publication No. 2002-237192.) The negative charge pump circuit shown in FIG. 5 includes n-channel MOS transistors (hereafter simply referred to as “transistors”) M101 to M105 coupled in series between a low-potential power supply terminal GND and an output terminal Vout and capacitive elements C101 to C104 disposed between nodes V1 to V4 between the transistors and a clock input terminal (CLK1 or CLK2). The transistors M101 to M105 are each diode-coupled. More specifically, the gates and back gates of the transistors M101 to M105 are coupled to first terminals (hereafter referred to as “sources” for the sake of convenience) thereof. A capacitance C105 is an output load capacitance (a capacitance loaded on the output terminal Vout). This negative charge pump circuit generates a negative voltage to the output terminal Vout by increasing or reducing the potentials of the nodes V1 to V4 in sync with step-up clocks CLK1 and CLK2 having opposite phases.

The transistors M101 to M105 are each disposed on a p-well disposed on an n-well disposed on a p-substrate. That is, the transistors M101 to M105 are each disposed on a triple-well structure. This forms parasitic transistors which use the p-well as the base, the n-well as the collector, and the n⁺ diffusion region disposed on the p-well as the emitter. As a result, useless current (parasitic current) passes between the emitter and collector of each parasitic transistor, disadvantageously increasing current consumption. (See FIG. 17 of Japanese Unexamined Patent Publication No. 2002-237192.)

A solution to such a problem is disclosed in Japanese Unexamined Patent Publication No. 2002-237192. FIG. 6 is a circuit diagram showing a negative charge pump circuit disclosed in Japanese Unexamined Patent Publication No. 2002-237192. (The diagram corresponds to FIG. 1 of Japanese Unexamined Patent Publication No. 2002-237192.)

In the negative charge pump circuit shown in FIG. 6, a row of series-coupled n-channel MOS transistors M111 to M114 and M116 and a row of series-coupled n-channel MOS transistors M121 to M124 and M126 are coupled in parallel between a low-potential power supply terminal (a reference voltage terminal) GND and an output terminal Vout. An n-channel MOS transistor M115 is disposed between a node V114 between the transistors M114 and M116 and the back gate of the transistor M126 (a node V115). An n-channel MOS transistor M125 is disposed between a node V124 between the transistors M124 and M126 and the back gate of the transistor M116 (a node V125). Capacitive elements C111 to C115 are disposed between nodes V111 to V114 and the above-mentioned node V115 between the transistors M111 to M114 and M116, and a clock input terminal (CLK1 or CLK2). Capacitive elements C121 to C125 are disposed between nodes V121 to V124 and the above-mentioned node V125 between the transistors M121 to M124 and M126 and a clock input terminal (CLK1 or CLK2).

The transistors M111 to M116 and the transistors M121 to M126 are each diode-coupled. More specifically, the gates of the transistors M111 to M116 are coupled to the sources thereof, respectively. A capacitance C105 is an output load capacitance (a capacitance loaded on the output terminal Vout). In this negative charge pump circuit, the respective rows generate a negative voltage to the output terminal Vout by turns by increasing or reducing the potentials of the nodes V111 to V115 or the nodes V121 to V125 in sync with step-up clocks CLK1 and CLK2 having opposite phases.

In the negative charge pump circuit shown in FIG. 6, the back gates of the transistors M111 to M114 in a first row are coupled to the nodes V122 to V125 in a second row. The back gates of the transistors M121 to M124 in the second row are coupled to the nodes V112 to V115 in the first row. In other words, in the negative charge pump circuit shown in FIG. 6, the back gates of the transistors M111 to M114 and M121 to M124 are subjected to output voltages of transistors immediately following these transistors in the opposite rows. Thus, the back gates of the transistors M111 to M114 and M121 to M124 always have a potential lower than the drain and source thereof. As a result, the negative charge pump circuit shown in FIG. 6 can suppress an increase in current consumption caused by the effect of the parasitic transistors, which has been a problem with the negative charge pump circuit shown in FIG. 5.

### SUMMARY

The related-art negative charge pump circuit shown in FIG. 6 generates low potentials to be applied to the back gates of the transistors M114 and M124 by including the transistors M115 and M125 and the capacitive elements C115 and C125. That is, the negative charge pump circuit shown in FIG. 6 must include a five-stage booster cell (a cell composed of transistors and capacitive elements), whose stage number is larger than that of usual negative charge pump circuits by one so as to generate a four-times higher step-up voltage. Further, the wiring lines extending to the back gates of the transistors are complicated in the negative charge pump circuit shown in FIG. 6. For these reasons, attempts to suppress current consumption in related-art negative charge pump circuits have disadvantageously led to increases in circuit size.

A charge pump circuit according to an aspect of the present invention includes: a first diode element disposed between a reference voltage terminal and a first node; a first transistor disposed between the first node and an external output terminal, a conduction state of the first transistor being controlled in accordance with a voltage level of a second node; and a first capacitive element having a first end coupled to the first node and a second end receiving a first clock signal; a second diode element disposed between the reference voltage terminal and the second node; a second transistor disposed between the second node and the external output terminal, a conduction state of the second transistor being controlled in accordance with a voltage level of the first node; and a second capacitive element having a first end coupled to the second node and a second end receiving a second clock signal having a phase opposite to the phase of the first clock signal. The first and second diode elements and the first and second transistors are each disposed on a triple well including an n-well, a p-well, and a p-substrate. The n-well and the p-well are electrically coupled to each other in at least the triple wells forming the first and second diode elements.

According to the above-mentioned circuit configuration, it is possible to reduce the current passing through parasitic transistors with the circuit size increase suppressed, thereby suppressing an increase in current consumption.

According to the aspect of the present invention, a charge pump circuit can be provided which can reduce the current passing through parasitic transistors with its circuit size increase suppressed, thereby suppressing an increase in current consumption.

### BRIEF DESCRIPTION OF THE DRAWINGS

FIG. 1 is a circuit diagram showing a charge pump circuit according to a first embodiment of the present invention;

FIG. 2 is a diagram showing the vertical structure of components forming the charge pump circuit according to the first embodiment;

FIG. 3 is a circuit diagram showing a charge pump circuit according to a second embodiment of the present invention;

FIG. 4 is a diagram showing the vertical structure of components forming the charge pump circuit according to the second embodiment;

FIG. 5 is a circuit diagram showing a negative charge pump circuit according to the related art;

FIG. 6 is a circuit diagram showing a negative charge pump circuit according to the related art; and

FIG. 7 is a diagram showing the vertical structure of components forming the charge pump circuit according to the related art.

### DETAILED DESCRIPTION

Now, embodiments of the present invention will be described with reference to the accompanying drawings. Since the drawings are only illustrative, the technical scope of the present invention should not be construed as limiting on the basis of the illustration. The same components are assigned the same characters and will not be described again.

### First Embodiment

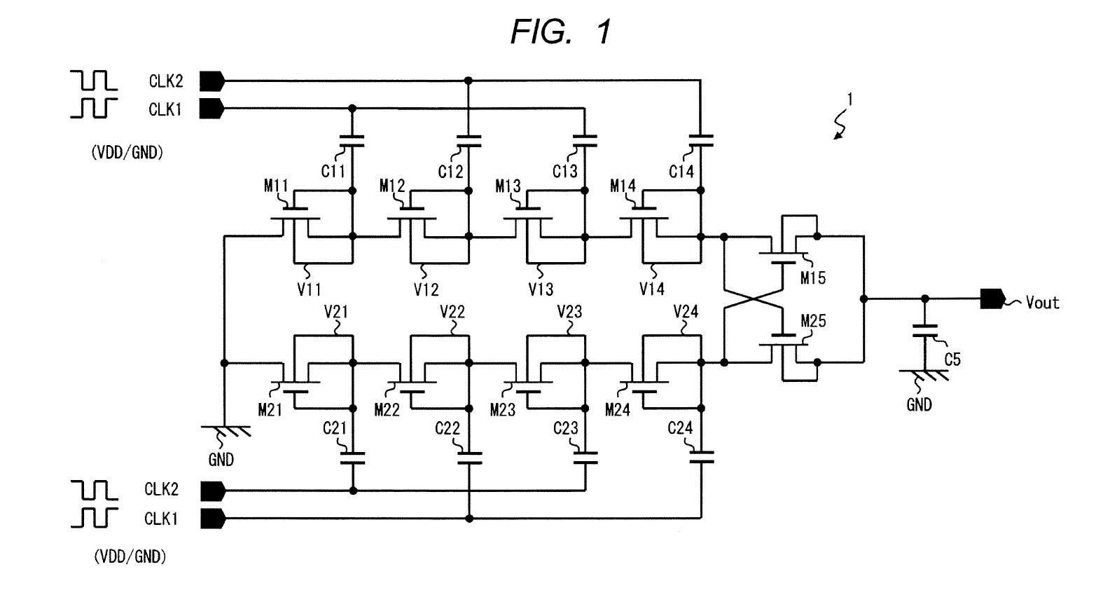

FIG. 1 is a diagram showing a charge pump circuit for negative voltage generation according to a first embodiment of the present invention. A charge pump circuit 1 according to this embodiment includes two rows of multiple transistors coupled in series between a reference voltage terminal and an external output terminal. It controls the conduction state of the output-stage transistor in each row in accordance with the output voltage of a transistor immediately preceding the output-stage transistor in the opposite row. Further, in at least the transistors other than the output-stage transistor of the charge pump circuit 1 according to this embodiment, the back gates of the transistors and n-wells included in triple wells on which the transistors are disposed are coupled to each other. That is, in the charge pump circuit 1 according to this embodiment, the n-wells and p-wells included in the triple wells are electrically coupled to each other in at least the transistors other than the output-stage transistor. Thus, the charge pump circuit according to this embodiment can reduce the current passing through parasitic transistors while suppressing increases in circuit size, thereby suppressing an increase in current consumption. A specific description will be made below.

First, the circuit configuration of the charge pump circuit 1 will be described. The charge pump circuit 1 for negative voltage generation shown in FIG. 1 includes n-channel MOS transistors (first diode elements; hereafter simply referred to as “transistors”) M11 to M14, a transistor (a first transistor) M15, transistors (second diode components) M21 to M24, a transistor (a second transistor) M25, capacitive components (first capacitive components) C11 to C14, and capacitive components (second capacitive components) C21 to C24. The transistors M11 to M15 are coupled in series between a low-potential power supply terminal (a reference voltage terminal) GND and an output terminal (an external output terminal) Vout. The transistors M21 to M25 are coupled in series between the low-potential power supply terminal GND and the output terminal Vout. That is, a row of the series-coupled transistors M11 to M15 and a row of the series-coupled transistors M21 to M25 are coupled in parallel between the low-potential power supply terminal GND and the output terminal Vout. The transistors M11 to M14 and M21 to M24 are each diode-coupled.

The capacitive components C11 to C14 are disposed between nodes V11 to V14 between the transistors M11 to M15, and a clock input terminal CLK1 or a clock input terminal CLK2. The capacitive components C21 to C24 are disposed between nodes V21 to V24 between the transistors M21 to M25, and the clock input terminal CLK1 or clock input terminal CLK2.

More specifically, for the transistor M11, its first terminal, gate, and back gate are coupled to the node V11, and its second terminal is coupled to the low-potential power supply terminal GND. In the following description, the first terminal coupled to the back gate and the second terminal are referred to as the source and the drain, respectively, for the sake of convenience. The same goes for the other MOS transistors included in the charge pump circuit 1.

For the transistor M12, its drain is coupled to the node V11, and its source, gate, and back gate to the node V12. For the transistor M13, its drain is coupled to the node V12, and its source, gate, and back gate to the node V13. For the transistor M14, its drain is coupled to the node V13, and its source, gate, and back gate to the node V14. For the transistor M15, its drain is coupled to the node V14, its source and back gate to the output terminal Vout, and its gate to the node V24 in the opposite row.

For the transistor M21, its drain is coupled to the low-potential power supply terminal GND, and its source, gate, and back gate to the node V21. For the transistor M22, its drain is coupled to the node V21, and its source, gate, and back gate to the node V22. For the transistor M23, its drain is coupled to the node V22, and its source, gate, and back gate to the node V23. For the transistor M24, its drain is coupled to the node V23, and its source, gate, and back gate to the node V24. For the transistor M25, its drain is coupled to the node V24, its source and back gate to the output terminal Vout, and its gate to the node V14 in the opposite row.

The capacitive element C11 is disposed between the clock input terminal CLK1 and the node V11. The capacitive element C12 is disposed between the clock input terminal CLK2 and the node V12. The capacitive element C13 is disposed between the clock input terminal CLK1 and the node V13. The capacitive element C14 is disposed between the clock input terminal CLK2 and the node V14. The capacitive element C21 is disposed between the clock input terminal CLK2 and the node V21. The capacitive element C22 is disposed between the clock input terminal CLK1 and the node V22. The capacitive element C23 is disposed between the clock input terminal CLK2 and the node V23. The capacitive element C24 is disposed between the clock input terminal CLK1 and the node V24. A capacitance C5 is an output load capacitance (a capacitance loaded on the output terminal Vout).

In the following description, the potentials of the nodes V11 to V14, the nodes V21 to V24, and the output terminal Vout may be referred to as V11 to V14, V21 to V24, and Vout, respectively. The potentials of the low-potential power supply terminal GND and a high-potential power supply VDD may be referred to as GND (0 V) and VDD, respectively. Clock signals supplied to the clock input terminals CLK1 and CLK2 are referred to as CLK1 and CLK2, respectively. The clock signals CLK1 and CLK2 have the same frequency but opposite phases. The clock signals CLK1 and CLK2 both indicate the potential GND when at the L level; they indicate the potential VDD when at the H level. The capacitive components C11 to C14 and C21 to 24 increase or reduce the potentials of the nodes V11 to V14 and V21 to 24, respectively, in sync with the clock signal CLK1 or clock signal CLK2.

Next, the operation of the charge pump circuit 1 will be described. For the sake of simplicity, the description will be made assuming that respective forward voltage drops Vf of the diode-coupled transistors M11 to M14 and M21 to M24 are 0 V.

First, when the clock signal CLK1 is at the H level and the clock signal CLK2 is at the L level, the potential VDD is applied to a first end of the capacitive element C11. This turns on the transistor M11, making the potential of the node V11 the same as that of the low-potential power supply terminal GND, that is, 0V. Thus, the voltage VDD is applied across the capacitive element C11. Next, when the clock signal CLK1 is changed to the L level and the clock signal CLK2 is changed to the H level, the potential GND is applied to the first end of the capacitive element C11. This turns off the transistor M11, so the potential of the node V11 becomes −VDD. At this time, the potential VDD is applied to a first end of the capacitance C12, turning on the transistor M12. Thus, the potential of the node V12 becomes the same as that of the node V11, that is, −VDD. Thus, the voltage VDD−(−VDD)=2VDD is applied across the capacitive element C12.

Next, when the clock signal CLK1 is changed to the H level and the clock signal CLK2 is changed to the L level, the potential GND is applied to a first end of the capacitive element C12. This turns off the transistor M12, so the potential of the node V12 becomes −2VDD. At this time, the potential VDD is applied to a first end of the capacitance C13, turning on the transistor M13. This makes the potential of the node V13 the same as that of the node V12, that is, −2VDD. Thus, the voltage VDD−(−2VDD)=3VDD is applied across the capacitive element C13.

Next, when the clock signal CLK1 is changed to the L level and the clock signal CLK2 is changed to the H level, the potential GND is applied to a first end of the capacitive element C13. This turns off the transistor M13, so the potential of the node V13 becomes −3VDD. At this time, the potential VDD is applied to a first end of the capacitance C14, so the transistor M14 is turned on. This makes the potential of the node V14 the same as that of the node V13, that is, −3VDD. Thus, the voltage VDD−(−3VDD)=4VDD is applied across the capacitive element C14.

Next, when the clock signal CLK1 is changed to the H level and the clock signal CLK2 is changed to the L level, the potential GND is applied to the first end of the capacitive element C14. This turns off the transistor M14, so the potential of the node V14 becomes −4VDD.

The other row (the row of the transistors M21 to M24) having an opposite phase is also subjected to the above-mentioned operation. Accordingly, when the clock signal CLK1 is at the H level and the clock signal CLK2 is at the L level, the node V14 indicates a potential of −4VDD and the node V24 indicates a potential of −3VDD. On the other hand, when the clock signal CLK1 is at the L level and the clock signal CLK2 is at the H level, the node V14 indicates a potential of −3VDD and the node V24 indicates a potential of −4VDD.

When the clock signal CLK1 is at the H level and the clock signal CLK2 is at the L level, the potential −3VDD is applied to the gate of the n-channel MOS transistor, the transistor M15, and the potential −4VDD is applied to the drain thereof. This turns on the transistor M15. Similarly, the potential −4VDD is applied to the n-channel MOS transistor, the transistor M25, and the potential −3VDD is applied to the drain thereof. This turns off the transistor M25.

In contrast, when the clock signal CLK1 is at the L level and the clock signal CLK2 is at the H level, the potential −4VDD is applied to the gate of the transistor M15, and the potential −3VDD is applied to the drain thereof. This turns off the transistor M15. The potential −3VDD is applied to the gate of the transistor M25, and the potential −4VDD is applied to the drain thereof. This turns on the transistor M25. As seen above, the transistors M15 and M25 are alternately turned on in sync with the clock signals CLK1 and CLK2, so the negative voltage (−4VDD) is given to the output terminal Vout.

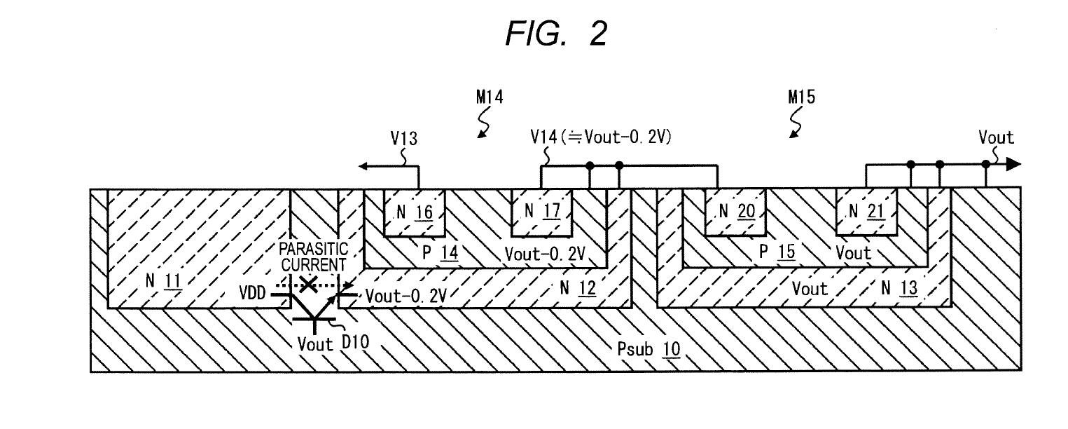

Next, the vertical structure of the components forming the charge pump circuit 1 will be described with reference to FIG. 2. FIG. 2 shows only the transistors M14 and M15 and another peripheral circuit (not shown in FIG. 1) for the sake of simplicity. The transistors M24 and M25 and another peripheral circuit have the same vertical structure as that shown in FIG. 2.

An n-well 12 for the transistor M14, an n-well 13 for the transistor M15, and an n-well 11 for another peripheral circuit to which the potential VDD is applied are disposed on a p-substrate (hereafter simply referred to as a “Psub”). A p-well 14 is disposed on the n-well 12. An n⁺ diffusion region 16 and an n⁺ diffusion region 17 are disposed on the p-well 14. The n⁺ diffusion region 16 serves as the second terminal (drain) of the transistor M14, the n⁺ diffusion region 17 as the first terminal (source) thereof, and the p-well 14 as the back gate thereof. A p-well 15 is disposed on the n-well 13. An n⁺ diffusion region 20 and an n⁺ diffusion region 21 are disposed on the p-well 15. The n⁺ diffusion region 20 serves as the second terminal (drain) of the transistor M15, the n⁺ diffusion region 21 as the first terminal (source) thereof, and the p-well 15 as the back gate thereof.

As shown in FIG. 2, the n⁺ diffusion region 16 is coupled to the node V13. The n⁺ diffusion region 17, the p-well 14, the n-well 12, and the n⁺ diffusion region 20 are coupled to the node V14. The n⁺ diffusion region 21, the p-well 15, the n-well 13, and the Psub 10 are coupled to the output terminal Vout. The n-well 13 may be coupled to the high-potential power supply VDD rather than to the output terminal Vout.

As seen above, the transistors M14 and M15 are each disposed on a triple-well structure composed of the Psub (10), the n-well (12, 13), and the p-well (14, 15). Similarly, the other transistors (not shown) are each disposed on a triple-well structure.

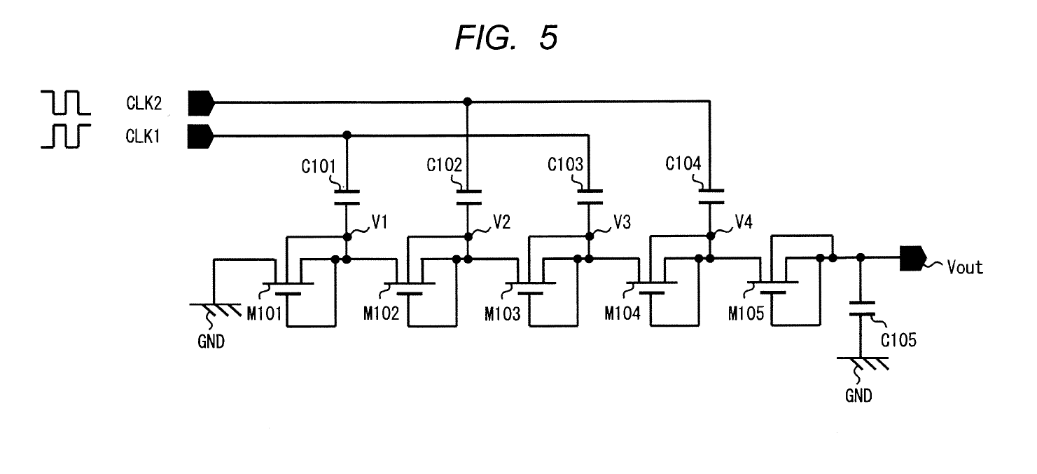

As described above, the p-well 14 and the n-well 12 are coupled to each other via the node V14, so these wells have the same potential. Unlike in the related art, this prevents formation of a parasitic transistor using the p-well 14 as the base, the n-well 12 as the collector, and the n⁺ diffusion region 16 as the emitter. The same goes for the other triple wells. The charge pump circuit 1 thus suppresses an increase in current consumption, which has been a problem with the related art shown in FIG. 5. Meanwhile, coupling of the n-well 13 to the high-potential power supply VDD forms a parasitic NPN bipolar transistor which uses the n⁺ diffusion region 20 as the emitter, the p-well 15 as the base, and the n-well 13 as the collector. However, the transistor M15 operates as an FET, so the potential difference between the p-well 15 and the n⁺ diffusion region 20 becomes about 0.2 V or less. This prevents turn-on of the parasitic NPN bipolar transistor, suppressing an increase in current consumption.

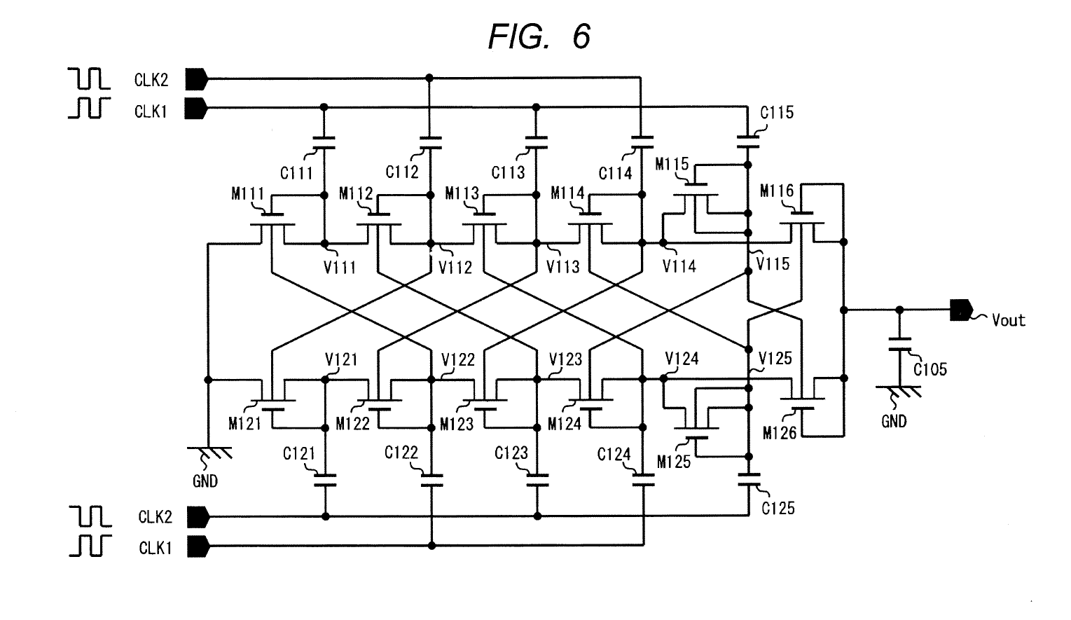

Further, unlike the related art shown in FIG. 6, the charge pump circuit 1 according to this embodiment does not need to include components corresponding to the transistors M115 and M125 and the capacitive components C115 and C125. Further, unlike in the related art shown in FIG. 6, the wiring lines extending to the back gates of the transistors are simplified in the charge pump circuit 1 according to this embodiment. For these reasons, an increase in circuit size is suppressed in the charge pump circuit 1 according to this embodiment.

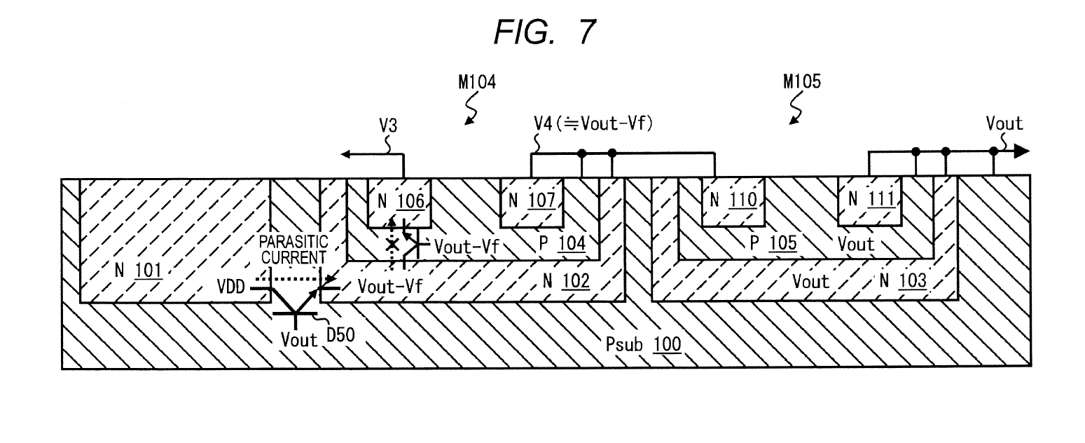

Next, the vertical structure of components in the case where the n-well and the p-well included in the triple well are electrically coupled to each other in the related-art charge pump circuit shown in FIG. 5 will be described with reference to FIG. 7. FIG. 7 shows only the transistors M104 and M105 and another peripheral circuit for the sake of simplicity. An n-well 102 for the transistor M104, an n-well 103 for the transistor M105, and an n-well 101 for another peripheral circuit to which the potential VDD is applied are disposed on a Psub 100. A p-well 104 is disposed on the n-well 102. An n⁺ diffusion region 106 and an n⁺ diffusion region 107 are disposed on the p-well 104. The n⁺ diffusion region 106 serves as the second terminal (drain) of the transistor M104, the n⁺ diffusion region 107 as the first terminal (source) thereof, and the p-well 104 as the back gate thereof. A p-well 105 is disposed on the n-well 103. An n⁺ diffusion region 110 and an n⁺ diffusion region 111 are disposed on the p-well 105. The n⁺ diffusion region 110 serves as the second terminal (drain) of the transistor M105, the n⁺ diffusion region 111 as the first terminal (source) thereof, and the p-well 105 as the back gate thereof.

As shown in FIG. 7, the n⁺ diffusion region 106 is coupled to a node V3. The n⁺ diffusion region 107, the p-well 104, the n-well 102, and the n⁺ diffusion region 110 are coupled to a node V4. The n⁺ diffusion region 111, the p-well 105, the n-well 103, and the Psub 100 are coupled to the output terminal Vout.

As described above, the p-well 104 and the n-well 102 are coupled to each other via the node V4, so these wells have the same potential. This prevents formation of a parasitic transistor using the p-well 104 as the base, the n-well 102 as the collector, and the n⁺ diffusion region 106 as the emitter. The same goes for the other triple wells. Accordingly, an increase in current consumption, which has been a problem with the related art shown in FIG. 5, is suppressed also in the case of FIG. 7.

However, since the p-well 104 and the n-well 102 are coupled, the potential of the n-well 102 becomes lower than the potential Vout of the Psub 100 by the forward voltage drop Vf (about 0.6 to about 0.7 V) of the diode-coupled transistor M105. That is, the potential of the n-well 102 becomes Vout−Vf. As described above, the potential of the n-well 101 is VDD. This forms a parasitic transistor D50 using the Psub 100 as the base, the n-well 102 as the emitter, and the n-well 101 as the collector. As a result, useless current (parasitic current) passes between the emitter and the collector of the parasitic transistor D50. Thus, the modification of the related art shown in FIG. 7 disadvantageously increases current consumption.

On the other hand, in the charge pump circuit 1 shown in FIGS. 1 and 2, the conduction state of the transistor M15 is controlled in accordance with the output voltage of the transistor M24 immediately preceding the transistor M15 in the opposite row, that is, the voltage of the node V24. Thus, the voltage drop of the transistor M15 obtained from the product of the on-resistance and the load current of the transistor M15 becomes as low as about 0.2 V. That is, the voltage drop of the transistor M15 becomes much lower than that in the related art. Although a parasitic transistor D10 using the Psub 10 as the base, the n-well 12 as the emitter, and the n-well 11 as the collector is formed, little base current flows from the Psub 10 (base) to the n-well 12 (emitter). Thus, little parasitic current flows from the collector, the n-well 11, to the emitter, the n-well 12. Similarly, the conduction state of the transistor M25 is controlled in accordance with the output voltage of the transistor M14 immediately preceding the transistor M25 in the opposite row, that is, the voltage of the node V14. Thus, the voltage drop of the transistor M25 becomes about 0.2 V, that is, much lower than that in the related art. Although a parasitic transistor is formed between the triple well (not shown in FIG. 2) forming the transistor M24 and the n-well 11, little base current flows. Thus, little parasitic current flows. As a result, the charge pump circuit 1 according to this embodiment reduces the current passing between the emitter and the collector of each parasitic transistor compared to the related art, suppressing an increase in current consumption.

As seen above, the charge pump circuit according to this embodiment can reduce the current passing through parasitic transistors with its circuit size increase suppressed, thereby suppressing an increase in current consumption.

### Second Embodiment

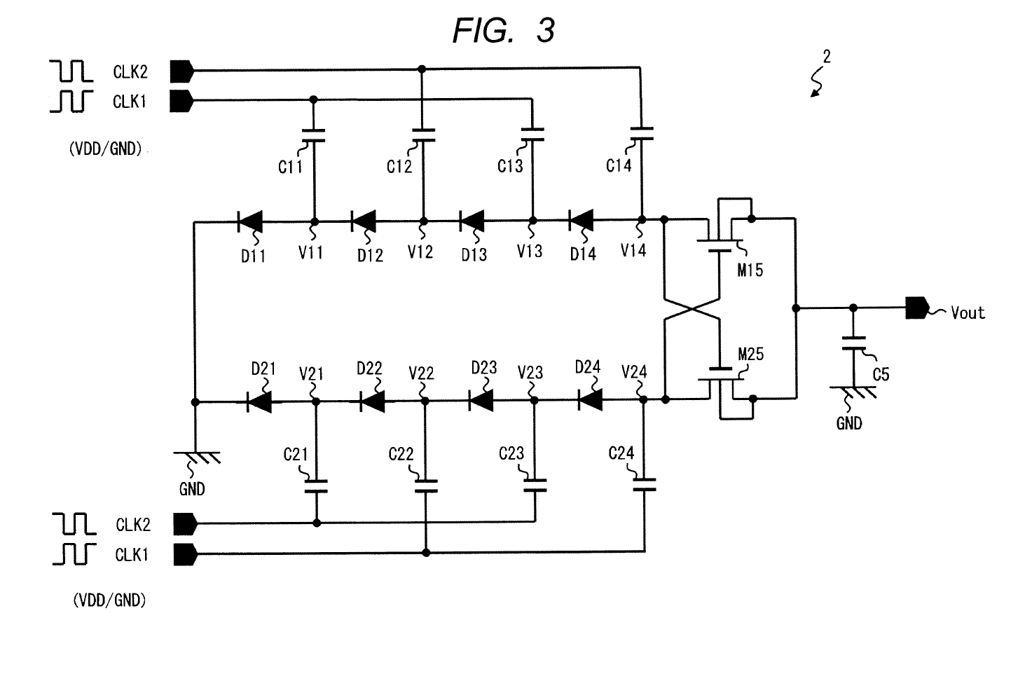

FIG. 3 is a diagram showing a charge pump circuit for negative voltage generation according to a second embodiment of the present invention. A charge pump circuit 2 according to this embodiment includes diodes D11 to D14 and D21 to D24 instead of the transistors M11 to M14 and M21 to M24 of the charge pump circuit 1 according to the first embodiment. The other circuit configuration of the charge pump circuit 2 shown in FIG. 3 is the same as that of the charge pump circuit 1 shown in FIG. 1 and will not be described. The charge pump circuit 2 shown in FIG. 3 performs the same operation as the charge pump circuit 1 shown in FIG. 1 does, and finally generates a desired negative voltage (−4VDD) to the output terminal Vout. This embodiment will be described assuming that the diodes D11 to D14 and D21 to D24 are p-n junction diodes.

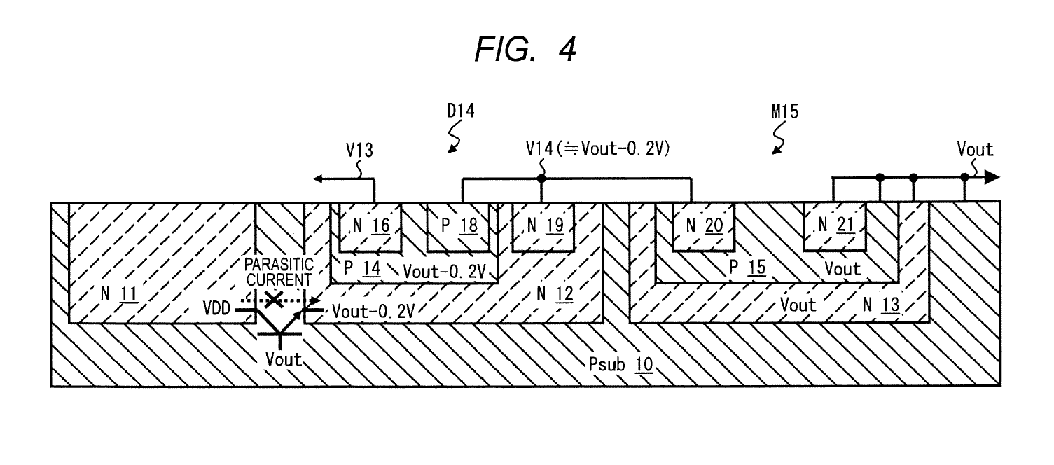

Next, the vertical structure of the components forming the charge pump circuit 2 will be described with reference to FIG. 4. FIG. 4 shows only the diode D14, the transistor M15, and another peripheral circuit for the sake of simplicity. The diode D24, the transistor M25, and another peripheral circuit have the same vertical structure as that shown in FIG. 4.

The n-well 12 for the diode D14, the n-well 13 for the transistor M15, and the n-well 11 for another peripheral circuit to which a potential VDD is applied are disposed on a Psub 10. The p-well 14 and an n⁺ diffusion region 19 are disposed on the n-well 12. An n⁺ diffusion region 16 and a p⁺ diffusion region 18 are disposed on the p-well 14. The n⁺ diffusion region 16 serves as the cathode of the diode D14, and the p⁺ diffusion region 18 as the anode of the diode D14. The other structure is the same as that shown in FIG. 2 and will not be described.

As shown in FIG. 4, the n⁺ diffusion region 16 is coupled to the node V13. The p⁺ diffusion region 18, the n⁺ diffusion region 19, and the n⁺ diffusion region 20 are coupled to the node V14. The n⁺ diffusion region 21, the p-well 15, the n-well 13, and the Psub 10 are coupled to the output terminal Vout.

As seen above, the diode D14 and the transistor M15 are each disposed on a triple-well structure composed of the Psub (10), the n-well (12, 13), and the p-well (14, 15). Similarly, the other diodes and another transistor (not shown) are each disposed on a triple-well structure.

As with the charge pump circuit 1 according to the first embodiment, the above-mentioned circuit configuration and component vertical structure can reduce the current passing through parasitic transistors with its circuit size increase suppressed, thereby suppressing an increase in current consumption.

The present invention is not limited to the above-mentioned first and second embodiments, and changes can be made to the embodiments as appropriate without departing from the spirit and scope of the invention. While the transistors or diodes other than the output-stage transistors M15 and M25 are disposed in two rows and four stages in the above-mentioned embodiments, the circuit configuration is not limited to this configuration. Transistors or diodes may be disposed in any number of stages so long as a desired voltage can be generated to the output terminal Vout.

What is claimed is:

1. A charge pump circuit comprising:
a first diode element disposed between a reference voltage terminal and a first node;
a first transistor disposed between the first node and an external output terminal, a conduction state of the first transistor being controlled in accordance with a voltage level of a second node;
a first capacitive element having a first end coupled to the first node and a second end receiving a first clock signal;
a second diode element disposed between the reference voltage terminal and the second node;
a second transistor disposed between the second node and the external output terminal, a conduction state of the second transistor being controlled in accordance with a voltage level of the first node; and
a second capacitive element having a first end coupled to the second node and a second end receiving a second clock signal having a phase opposite to the phase of the first clock signal,
wherein the first and second diode elements and the first and second transistors are each disposed on a triple well including an n-well, a p-well, and a p-substrate, and
wherein the n-well and the p-well are electrically coupled to each other in at least the triple wells forming the first and second diode elements.

2. The charge pump circuit according to claim 1,
wherein the first diode element comprises a plurality of series-coupled first diode components,
wherein the first capacitive element comprises a plurality of first capacitive components whose first ends are coupled to junctions of the first diode components and the first transistor and whose second ends alternately receive the first and second clock signals having opposite phases,
wherein the second diode element comprises a plurality of series-coupled second diode components, and
wherein the second capacitive element comprises a plurality of second capacitive components whose first ends are coupled to junctions of the second diode components and the second transistor and whose second ends alternately receive the first and second clock signals having opposite phases.

3. The charge pump circuit according to claim 1, wherein the first and second diode components are diode-coupled metal-oxide-semiconductor transistors.

4. The charge pump circuit according to claim 1, wherein the first and second diode components are p-n junction diodes.
